(19) United States
(12) Patent Application Publication
(10) Pub. No.: US 2026/0235446 A1
(43) Pub. Date: Aug. 13, 2026

(54) INFRARED IMAGING DEVICE

(71) Applicant: Mitsubishi Electric Corporation, Tokyo (JP)

(72) Inventor: Tomohiro MAEGAWA, Tokyo (JP)

(73) Assignee: Mitsubishi Electric Corporation, Tokyo (JP)

(21) Appl. No.: 19/470,796

(22) PCT Filed: Jul. 25, 2023
(86) PCT No.: PCT/JP2023/027149

§ 371 Date: Sep. 29, 2025

(51) Int. Cl. G01J 5/06; G01J 1/44; G01J 5/00; G01J 5/48; G01J 5/70; H04N 23/23; H04N 25/21; H04N 25/673; H04N 25/772

(52) U.S. Cl. CPC G01J 5/064; G01J 1/44; G01J 5/48; G01J 5/70; H04N 23/23; H04N 25/21; H04N 25/673; H04N 25/772; G01J 2005/0077

(57) ABSTRACT

The infrared imaging device comprises an imaging element, an ADC that converts it into a digital signal, a frame memory storing it as a thermal image, a background information memory storing background information, a state determination unit that determines whether a subtraction value from the thermal image minus the background information is greater than thA, a background information update unit that, for each pixel, sets T and B as the values of the thermal image and background, uses a number a, calculates f(a, T, B) so T/B increases with a, and updates the background information memory with the calculated value, and a thermal image generation unit that subtracts the background information from the thermal image and outputs a corrected thermal image, wherein the state determination unit sets a as a1 or a2 depending on whether the subtraction value is greater than thA, with a1<a2.

### FIELD

The present disclosure relates to an infrared imaging device.

### BACKGROUND

Conventionally, infrared imaging devices capable of capturing two-dimensional images have been used for professional, industrial, or military purposes in fields such as surveillance cameras, night vision devices, thermography, or forward monitoring devices mounted on vehicles and aircraft. On the other hand, in recent years, for example, infrared imaging devices capable of capturing two-dimensional images using SOI (Silicon On Insulator) diodes have been mounted on home air conditioners, the cost of infrared imaging devices has been reduced, and utilization in consumer applications has also emerged.

In a thermal-type infrared imaging device, an imaging element is configured by arranging pixels having a heat-insulating structure in a two-dimensional array, and infrared images are captured by utilizing temperature changes of the pixels caused by incident infrared radiation. Specifically, an electric signal is generated by injecting a current or applying a voltage to the pixels. By the incidence of infrared radiation, the temperature of the pixels is slightly varied, and the electric signal is slightly varied. This variation in the electric signal is amplified, converted into a digital signal, and output to the outside.

Here, the temperature of the pixels is influenced not only by the temperature change due to the incident infrared radiation, but also by the self-heating of the pixels caused by applying the current or voltage, the heat generation of components of the imaging element, and the change in the environmental temperature. Further, due to variations in the heat-insulating performance of each pixel, the power consumption, the applied voltage, and the amount of current, the degree of self-heating differs among pixels, resulting in differences in output levels among pixels. Variations in amplifiers also cause differences in output levels. These differences in output levels appear as fixed-pattern noise with respect to the imaging element, and are referred to as Fixed Pattern Noise (FPN). Because the heat-insulating performance and the power consumption of each pixel vary depending on the environmental temperature, the variation in output levels due to changes in environmental temperature becomes significant.

As described above, thermal image data captured by the infrared imaging device includes both actual captured data representing the energy emitted from a subject and fixed-pattern noise specific to the device. Therefore, in order to obtain a correct thermal image, it is necessary to generate fixed-pattern noise data and to remove the fixed-pattern noise data from the captured thermal image data.

As methods for acquiring fixed-pattern noise data, known methods include a method of capturing an image while the optical system is covered with a shutter to block infrared radiation from the outside, and a method of performing calibration without closing a correction shutter while directing the optical axis toward an object considered to have a relatively uniform temperature (for example, “the sky”) and with the lens defocused.

However, in consumer applications, low cost is important, and in order to further reduce the cost, it is desirable that the mechanical shutter used to acquire fixed-pattern noise data from the optical system of the infrared imaging device be eliminated and that the optical system have a fixed focus.

For example, PTL 1 discloses an infrared imaging device that acquires fixed-pattern noise data without using a mechanical shutter.

### CITATION LIST

### Patent Literature

[PTL 1] International Publication WO2022/264390

### SUMMARY

### Technical Problem

In the infrared imaging device described in PTL 1, fixed-pattern noise data is generated using multiple image information. Therefore, a frame memory capable of storing multiple images is required. As a result, the memory capacity required for the frame memory increases.

The present disclosure has been made to address the above problems, and an object of the present disclosure is to provide an infrared imaging device capable of limiting the increase in memory capacity required for the frame memory.

### Solution to Problem

The infrared imaging device according to the present disclosure comprises an imaging element that receives infrared light emitted from an imaging target region including a subject and a background and outputs an electric signal according to the intensity of the infrared light, an ADC that converts the electric signal into a digital signal, a frame memory that stores the digital signal as a thermal image, a background information memory that stores background information calculated based on the thermal image, a state determination unit that determines, for each pixel, whether a subtraction value obtained by subtracting the background information from the thermal image is greater than thA, which is a positive threshold, a background information update unit that, for each pixel, sets the value of the thermal image as T, sets the value of the background information as B, uses a number a, calculates a function f(a, T, B) in which the ratio of T among T and B increases as a increases, and updates and stores the calculated value as new background information in the background information memory, and a thermal image generation unit that, for each pixel, subtracts the background information from the thermal image and outputs the result as a corrected thermal image, wherein the state determination unit sets the value of a as a1 when it is determined that the subtraction value is greater than thA, sets the value of a as a2 when it is determined that the subtraction value is not greater than thA, and the a1 and a2 satisfy a1<a2.

### Advantageous Effects of Invention

According to the present disclosure, an infrared imaging device capable of limiting the increase in memory capacity required for the frame memory can be obtained.

### BRIEF DESCRIPTION OF DRAWINGS

FIG. 1 is a diagram showing a configuration of an infrared imaging device according to First embodiment.

FIG. 2 is a flowchart showing an operation of the infrared imaging device according to First embodiment.

FIG. 3 is a diagram showing thermal images before and after correction of the infrared imaging device according to First embodiment.

FIG. 4 is a diagram showing frequencies of thermal images before and after correction of the infrared imaging device according to First embodiment.

FIG. 5 is a diagram showing frequencies of thermal images before and after correction of the infrared imaging device according to First embodiment.

FIG. 6 is a diagram showing a configuration of an infrared imaging device according to Second embodiment.

FIG. 7 is a flowchart showing an operation of the infrared imaging device according to Second embodiment.

FIG. 8 is a flowchart showing an operation of the infrared imaging device according to Second embodiment.

FIG. 9 is a diagram showing frequencies of thermal images before and after correction of the infrared imaging device according to Second embodiment.

FIG. 10 is a diagram showing a thermal image output from the infrared imaging device according to Second embodiment.

FIG. 11 is a diagram for explaining a method of calculating a temperature subtraction value of the infrared imaging device according to Second embodiment.

FIG. 12 is a diagram for explaining a method of calculating a temperature subtraction value of the infrared imaging device according to Second embodiment.

FIG. 13 is a diagram for explaining a method of calculating a temperature subtraction value of the infrared imaging device according to Second embodiment.

FIG. 14 is a diagram showing a configuration of an infrared imaging device according to Third embodiment.

FIG. 15 is a diagram showing a configuration of a modification of the infrared imaging device according to Third embodiment.

FIG. 16 is a flowchart showing an operation of the infrared imaging device according to Third embodiment.

FIG. 17 is a flowchart showing an operation of the infrared imaging device according to Third embodiment.

FIG. 18 is a diagram showing frequencies of thermal images before and after correction of the infrared imaging device according to Third embodiment.

FIG. 19 is a diagram showing a configuration of an infrared imaging device according to Fourth embodiment.

FIG. 20 is a flowchart showing an operation of the infrared imaging device according to Fourth embodiment.

FIG. 21 is a diagram showing frequencies of thermal images before and after correction of the infrared imaging device according to Fourth embodiment.

FIG. 22 is a diagram showing a configuration of an infrared imaging device according to Fifth embodiment.

FIG. 23 is a flowchart showing an operation of the infrared imaging device according to Fifth embodiment.

FIG. 24 is a diagram showing thermal images before and after correction and frequencies thereof of the infrared imaging device according to Fifth embodiment.

### DESCRIPTION OF EMBODIMENTS

### First Embodiment

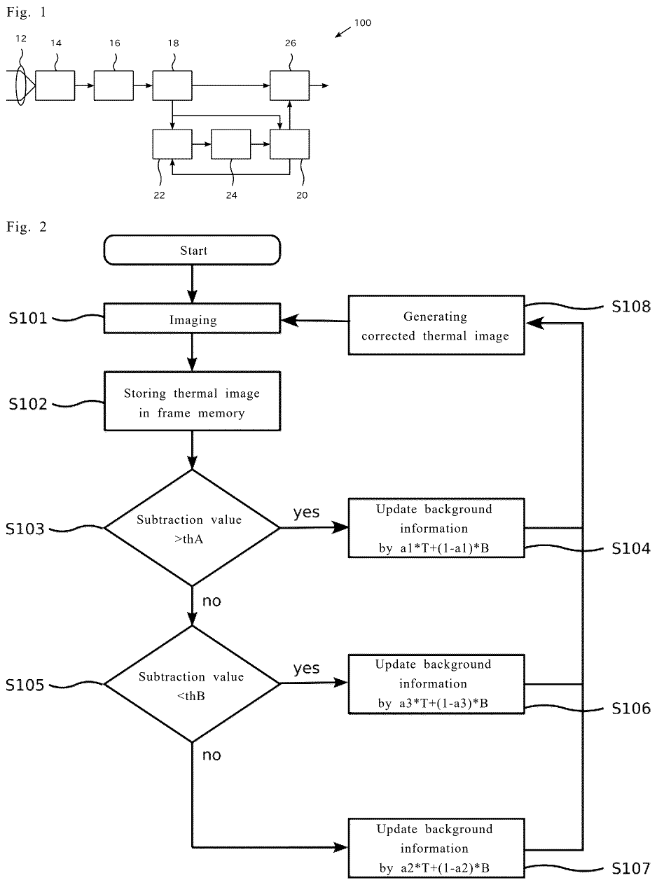

FIG. 1 is a diagram showing a configuration of an infrared imaging device 100 according to First embodiment. The infrared imaging device 100 includes an optical system 12, an imaging element 14, an ADC 16, a frame memory 18, a state determination unit 22, a background information update unit 24, a background information memory 20, and a thermal image generation unit 26.

The optical system 12 is an imaging optical system including one or more lenses, and receives and condenses infrared radiation emitted from an imaging target region including a subject and a background.

The imaging element 14 includes a plurality of pixels arranged in a two-dimensional array, receives infrared radiation condensed by the optical system 12, and outputs an electrical signal corresponding to the intensity of the infrared radiation from each pixel. Each pixel is, for example, a temperature sensor formed of an SOI diode having a heat insulating structure. Alternatively, an imaging element having a resistive bolometer structure or a thermopile structure may be used. Each pixel receives infrared radiation through the optical system 12, and outputs a voltage signal corresponding to the intensity of the infrared radiation by utilizing a change in pixel temperature caused by the received infrared radiation. The voltage signal is output as an analog voltage signal. Imaging is performed at fixed intervals.

The ADC 16 is an A/D converter (Analog to Digital Converter) that converts an electrical signal output from the imaging element 14 into a digital signal and outputs the digital signal.

The frame memory 18 is a memory that stores, as a thermal image, the digital signal output from the ADC 16. Data stored in the frame memory 18 is two-dimensional thermal image data corresponding to infrared intensity received by pixels of the imaging element 14. The thermal image includes not only components corresponding to the intensity of infrared radiation emitted from the imaging target region but also fixed pattern noise inherent to the imaging element 14. When the imaging target region includes a moving subject such as a person, the thermal image includes both components emitted from the subject and components generated from the background that does not involve movement. Data constituting one thermal image is referred to as frame data. The data is handled on a frame-by-frame basis.

The state determination unit 22 calculates, for each pixel, a difference between a thermal image stored in the frame memory 18 and background information stored in the background information memory 20 described later, and determines whether the state is a subject imaging state, a background imaging state, or a false detection state. Processing by the state determination unit 22 may be performed for each frame or once every plurality of frames. These states will be described in detail later.

The background information update unit 24 performs weighting, for each pixel, between the thermal image stored in the frame memory 18 and the background information stored in the background information memory 20, in accordance with the state determined by the state determination unit 22, and updates and stores the result in the background information memory 20 as new background information.

The background information memory 20 is a memory that stores background information. The background information is two-dimensional data that may include information on a background region of the imaging target region as well as information on a background located behind a subject, even in a region where the subject is present. The data size is the same as that of the thermal image stored in the frame memory 18. The background information also includes fixed pattern noise inherent to the imaging element 14.

The thermal image generation unit 26 subtracts, for each pixel, the background information stored in the background information memory 20 from the thermal image stored in the frame memory 18, and outputs the result as a corrected thermal image.

Hereinafter, operation of the infrared imaging device 100 according to First embodiment will be described. FIG. 2 is a flowchart illustrating operation of the infrared imaging device 100.

When the infrared imaging device 100 starts operation, in step S101, imaging is performed by the imaging element 14. Next, in step S102, the ADC 16 converts a two-dimensional electrical signal obtained by imaging of the imaging element 14 into a thermal image, which is stored in the frame memory 18. At the initial stage immediately after the infrared imaging device 100 starts operation, the background information first stored in the background information memory 20 may be a thermal image first stored in the frame memory 18, a thermal image stored in the frame memory 18 after operation becomes stable, or a pre-prepared pattern. Using the first thermal image stored in the frame memory 18 allows early start of image acquisition. Using a thermal image stored in the frame memory 18 after operation becomes stable avoids unstable image output immediately after startup. Immediately after startup, the sensor output image may be disturbed due to voltage instability or the like. Moreover, as the sensor temperature changes toward a stable state, temperature drift occurs, so output stored in the frame memory 18 is likely to vary greatly. Therefore, correction is more likely to be successful after the state becomes relatively stable. Furthermore, by using a pre-prepared pattern, it is possible to avoid an unstable state immediately after startup and shorten the time required until stable driving is achieved.

Next, in step S103, state determination is performed by the state determination unit 22. In step S103, for each pixel, a subtraction value is calculated by subtracting background information stored in the background information memory 20 from a thermal image stored in the frame memory 18. When the subtraction value is larger than a positive threshold value thA, the pixel is determined to be in a subject imaging state. Generally, the surface temperature of a human subject is assumed to be about 33-34° C., which is higher than the background temperature or ambient temperature. Therefore, when the subtraction value is larger than thA, it is considered that the pixel is in a state where a subject has been imaged (subject imaging state).

When it is determined that the pixel is in the subject imaging state, in step S104, the background information update unit 24 updates and stores in the background information memory 20 a value calculated by an expression a1*T+(1−a1)*B, using a number a1 satisfying 0<a1<1, as new background information. Here, T is a value of a target pixel of the thermal image stored in the frame memory 18, and B is a value of the corresponding pixel of the background information. At this time, since the target pixel is in the subject imaging state, the updated background information preferably includes less of the values of the thermal image stored in the frame memory 18 and more of the background information. Therefore, it is preferable that a1 be set to a small value. As a result, even when the subject stays in one place for a long time, attenuation of subject information in the corrected thermal image output from the thermal image generation unit 26 can be suppressed. Hereinafter (including other embodiments), the background information update unit 24 updates and stores, in the background information memory 20, a value calculated by a function f(a, T, B)=a*T+(1−a)*B, where a satisfies 0<a<1, as new background information. However, the range of a and the form of the function f(a, T, B) are not limited, as long as the proportion of T relative to B increases as a increases.

When it is not determined that the pixel is in the subject imaging state in step S103, the process proceeds to step S105, and if the subtraction value is smaller than a negative threshold value thB, the pixel is determined to be in a false detection state. In such a pixel, it is determined that the temperature is lower than the background by more than the threshold, and normally such a pixel is considered to be in a state where false detection has occurred (false detection state).

When it is determined that the pixel is in the false detection state, in step S106, the background information update unit 24 updates and stores in the background information memory 20 a value calculated by an expression a3*T+(1−a3)*B, using a number a3 satisfying 0<a3<1, as new background information. At this time, since the target pixel is in the false detection state, the updated background information preferably includes more of the values of the thermal image stored in the frame memory 18 and less of the background information. Therefore, it is preferable that a3 be set to a large value.

When it is not determined that the pixel is in the false detection state in step S105, the pixel is considered to be in a state where the background is imaged (background imaging state). The process proceeds to step S107, where the background information update unit 24 updates and stores in the background information memory 20 a value calculated by an expression a2*T+(1−a2)*B, using a number a2 satisfying 0<a2<1, as new background information. At this time, since the target pixel is in the background imaging state, it is preferable to set the value of a2 between a1 and a3.

Here, summarizing the magnitude relationship among a1, a2, and a3, it is desirable that the relationship be a1<a2<a3. However, the relationship is not limited to this, depending on time constraints until image smoothing, required degree of image smoothing, and the like. Although a1 has been described as satisfying 0<a1<1, it is not limited to this, and may include 0 or 1, or may even be less than 0 or greater than 1. The same applies to a 2 and a 3. The condition 0<a1<1 is employed so that even when sudden variations in the image occur due to a drop in device voltage, instantaneous incidence of external light, or the like, the image can be readily restored to a smoothed state.

Furthermore, values of thA and thB are preferably set so that the subject imaging state, the background imaging state, and the false detection state can be appropriately discriminated, taking into account output of the thermal image generation unit 26, the amount of noise included in the output of the thermal image generation unit 26, and an analog-to-digital conversion gain of the ADC 16. Absolute values of thA and thB may be the same, or may be set to different values. It should be noted that although thA and thB have been described as threshold values using constant values, the number of thresholds may be changed according to the number of states to be distinguished, and the thresholds themselves may be varied depending on the image state. The same applies to the numbers a1, a2, and a3.

After one of the processes of step S104, S106, or S107 is completed, the process proceeds to step S108, where the thermal image generation unit 26 subtracts, for each pixel, the background information stored in the background information memory 20 from the thermal image stored in the frame memory 18, and generates and outputs a corrected thermal image. Through the above operation, the proportion of fixed pattern noise and background information in the background information increases, and by repeating this operation, the proportion increases further, so that the corrected thermal image output from the thermal image generation unit 26 emphasizes the contour of the subject. Thereafter, the process returns to step S101 for the next imaging.

The series of processes in steps S102 to S108 is executed for each pixel, but the series of processes may be executed for one pixel at a time. Alternatively, after one process or a plurality of processes are executed for all pixels, the next process may again be executed pixel by pixel.

It should be noted that the state determination unit 22 determines, for each pixel, the subject imaging state, the background imaging state, and the false detection state by comparing a subtraction value obtained by subtracting the background information stored in the background information memory 20 from the thermal image stored in the frame memory 18 with a threshold value. However, the determination method is not limited to this. For example, another image processing method may be used instead of subtraction calculation, another determination method may be employed for the threshold, or the threshold may be variable.

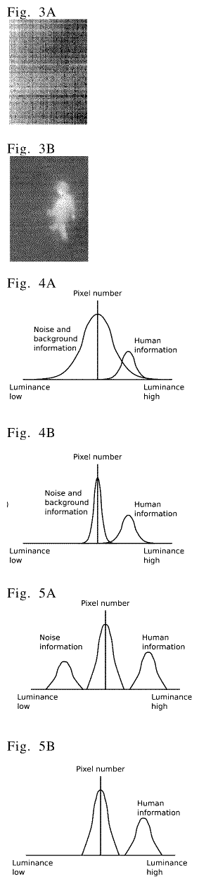

Hereinafter, a relationship between a thermal image stored in a frame memory 18 and a corrected thermal image output from a thermal image generation unit 26 will be described. FIG. 3(a) illustrates an example of a thermal image stored in the frame memory 18, and FIG. 4(a) schematically illustrates a frequency of pixel values of the thermal image of FIG. 3(a). The horizontal axis in FIG. 4 represents pixel intensity. In FIG. 4, the largest region indicates a region corresponding to fixed pattern noise and background information, which is indicated as “Noise and background information” in the figure. Further, in FIG. 4, a region located on the higher-intensity side (the right-hand side of the figure), which is indicated as “Human information,” represents subject information. This thermal image includes fixed pattern noise, information corresponding to the intensity of infrared radiation emitted from the imaging target region, information emitted from a moving subject, and information of a stationary background. Therefore, it becomes difficult to visually recognize subject information. FIG. 4(a) illustrates a state in which the subject information is hidden behind the fixed pattern noise and the background.

FIG. 3(b) illustrates a corrected thermal image output from the thermal image generation unit 26 based on the thermal image of FIG. 3(a), and FIG. 4(b) schematically illustrates a frequency of pixel values of the corrected thermal image of FIG. 3(b). The corrected thermal image output from the thermal image generation unit 26 is obtained by subtracting background information from the thermal image. Since the background information includes not only information regarding the background but also fixed pattern noise, FIG. 3(b) shows a clearer image with sharper contours compared with FIG. 3(a). Similarly, in FIG. 4(b), the subject region (“Human information”) is separated and distinguished from the background region (“Background information”).

Hereinafter, temporal changes of the corrected thermal image output from the thermal image generation unit 26 will be described. FIG. 5(a) schematically illustrates a frequency of pixel values in the corrected thermal image output from the thermal image generation unit 26.

Since the subject is in a subject imaging state and has a higher temperature than the background, it appears on the higher-temperature side (the region indicated as “Human information”) in FIG. 5(a). Pixels in this state retain more information of the thermal image stored in the frame memory 18 compared to background information. Therefore, even if the movement of the subject is extremely slow, attenuation of the output from the thermal image generation unit 26 is gradual. As a result, long-term imaging of the subject becomes possible.

Conversely, a portion in a false detection state shifts toward the lower-temperature side (the region indicated as “Noise information”). Pixels in this state reflect thermal image information of the frame memory 18 to the background information with a smaller ratio, so that the output from the thermal image generation unit 26 attenuates quickly. Consequently, restoration to a smooth image is promptly performed. FIG. 5(b) schematically illustrates a state in which a pixel in the false detection state has attenuated.

A portion in a background imaging state is located near zero. Pixels in this state reflect the thermal image information of the frame memory 18 to the background information with a larger ratio, so that the output from the thermal image generation unit 26 attenuates quickly.

As described above, an infrared imaging device 100 according to the first embodiment determines, for each pixel, whether the pixel is in a subject imaging state, a background imaging state, or a false detection state, based on one captured thermal image, and updates background information according to the determined state. Therefore, only one thermal image needs to be stored in the frame memory 18, thereby suppressing an increase in memory capacity required for the frame memory.

In addition, the background information stores information of a background image and fixed pattern noise, and the corrected thermal image is output by subtracting the background information from the thermal image stored in the frame memory 18. Therefore, the corrected thermal image that is output has enhanced subject contours, and the influence of fixed pattern noise is reduced.

Furthermore, since updating of the background information is not stopped even when the subject is moving, it is possible to obtain an image obtained by subtracting always-updated background information.

Moreover, when the subject is stationary, that portion is determined to be in the subject imaging state, and reflection of subject information to the background information is reduced. Accordingly, the problem of a sudden decrease in the output value of the subject is mitigated.

Further, since the background information including fixed pattern noise information is automatically generated during operation of the infrared imaging device, it is not necessary to provide a process for generating fixed pattern noise during manufacturing.

### Second Embodiment

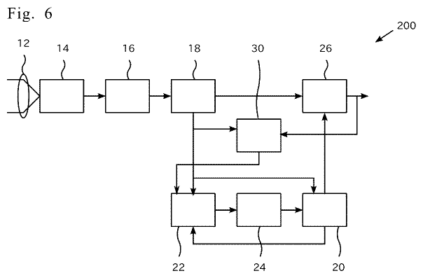

FIG. 6 illustrates a configuration of an infrared imaging device 200 according to a second embodiment. The infrared imaging device 200 according to the second embodiment is similar to the infrared imaging device 100 according to the first embodiment, but further includes an environment determination unit 30 configured to determine whether or not the temperature of the subject is lower than that of the background, and changes its operation according to the determination result.

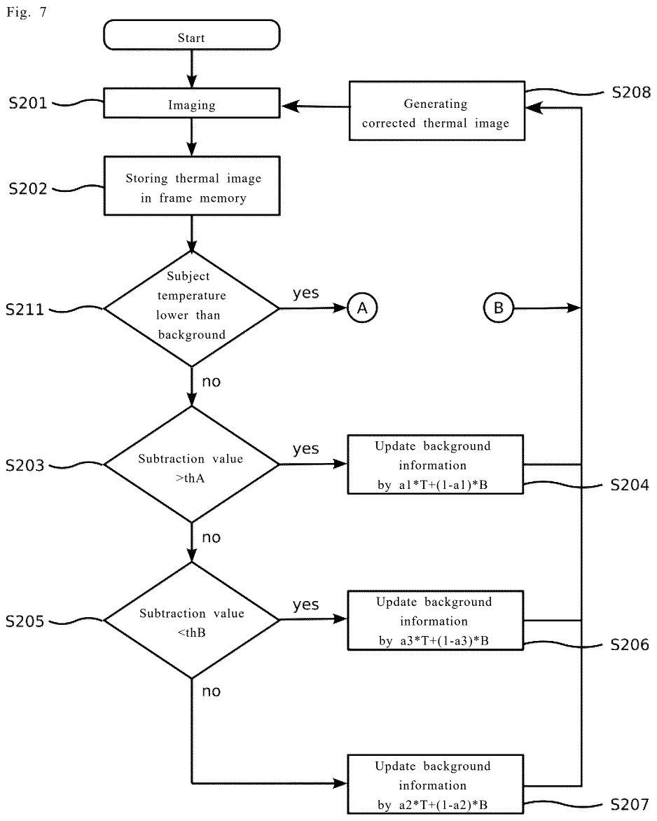

Hereinafter, an operation of an infrared imaging device 200 according to the second embodiment will be described. FIGS. 7 and 8 are flowcharts showing the operation of the infrared imaging device 200. A in FIG. 7 is connected to A in FIG. 8, and B in FIG. 8 is connected to B in FIG. 7. Since steps S201 to S202 are the same as steps S101 to S102 in FIG. 2 of the first embodiment, description thereof will be omitted.

In step S211, which is the next process after step S202, an environment determination unit 30 determines whether or not the temperature of a subject is lower than that of a background. Specifically, a temperature subtraction value corresponding to a value obtained by subtracting a representative value of the background temperature from a representative value of the subject temperature is calculated, and whether or not the subject temperature is lower than the background temperature is determined based on whether the temperature subtraction value is a negative value. If it is determined that the subject temperature is not lower than the background temperature, the process proceeds to step S203. Since steps S203 to S208 are the same as steps S103 to S108 in FIG. 2 of the first embodiment, description thereof will be omitted.

If it is determined in step S211 that the subject temperature is lower than the background temperature, the process proceeds to step S213, and a state determination is performed by a state determination unit 22. The process proceeds to step S213 only when it is determined that the subject temperature is lower than the background temperature. If not determined as such, as described above, the process proceeds to the same steps (S203-S207) as in the first embodiment.

Steps S213 to S217 are similar operations to steps S103 to S107 in FIG. 2 of the first embodiment. In step S213, for each pixel, if a subtraction value obtained by subtracting background information stored in a background information memory 20 from the thermal image stored in the frame memory 18 is determined to be smaller than a negative threshold value thC, the pixel is determined to be in a subject imaging state.

If it is determined to be in the subject imaging state, in step S214, a background information update unit 24 updates and stores in the background information memory 20 new background information calculated by the formula b1*T+(1−b1)*B using a number b1 satisfying 0<b1<1.

If it is not determined to be in the subject imaging state in step S213, the process proceeds to step S215, and for each pixel, if the subtraction value is determined to be greater than a positive threshold value thD, the pixel is determined to be in a false detection state.

If it is determined to be in the false detection state, in step S216, the background information update unit 24 updates and stores in the background information memory 20 new background information calculated by the formula b3*T+(1−b3)*B using a number b3 satisfying 0<b3<1.

If it is not determined to be in the false detection state in step S215, the pixel is regarded as being in a state in which the background is imaged (a background imaging state). Then, in step S217, the background information update unit 24 updates and stores in the background information memory 20 new background information calculated by the formula b2*T+(1−b2)*B using a number b2 satisfying 0<b2<1.

Here, b1, b2, and b3 desirably satisfy the relationship b1<b2<b3, for the same reasons as described in the first embodiment. However, the relationship is not limited to the above, depending on time constraints until image smoothing is achieved, requirements of image smoothness, and the like.

After completion of any one of steps S214, S216, and S217, the process proceeds to step S208, which is the same as step S108 in FIG. 2 of the first embodiment.

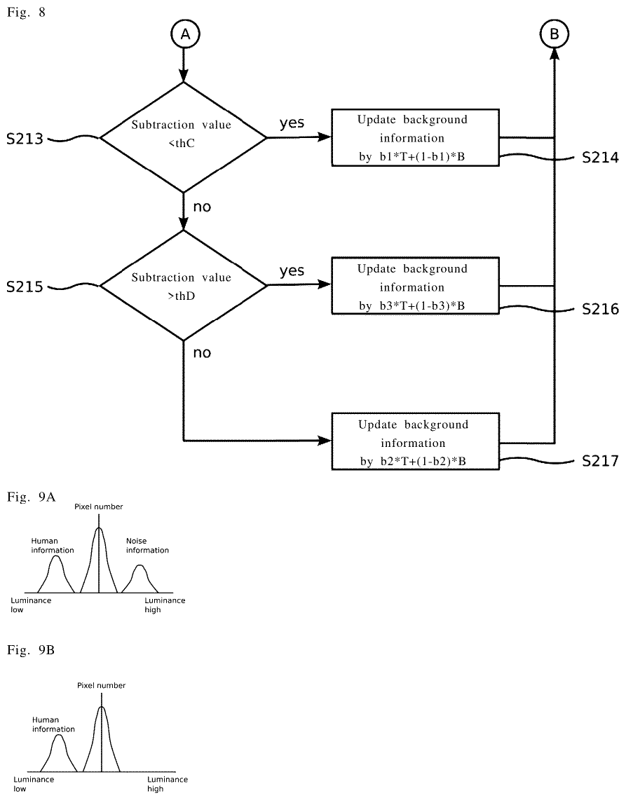

Hereinafter, a temporal change of a corrected thermal image output by the thermal image generation unit 26 will be described. FIG. 9(a) schematically shows a frequency distribution of pixel values in the corrected thermal image output by the thermal image generation unit 26. This example corresponds to a case where the subject temperature is lower than the background temperature.

The subject is in a subject imaging state, and since the temperature is lower than that of the background, in FIG. 9(a), the pixels are located on the low-temperature side (the region indicated as “Human information”). For the pixels in this state, for the same reasons as described in the first embodiment, long-term imaging of the subject is possible.

Conversely, pixels in a false detection state are located on the high-temperature side (the region indicated as “Noise information”). For the pixels in this state, for the same reasons as described in the first embodiment, the output from the thermal image generation unit 26 rapidly decays. As a result, recovery to a smooth image is quickly performed. FIG. 9(b) schematically shows the state in which pixels in the false detection state have decayed.

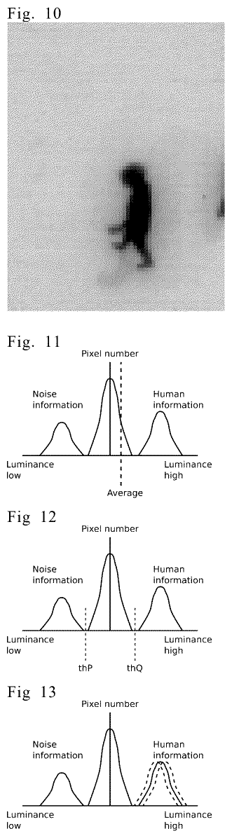

FIG. 10 shows an example of a corrected thermal image output by the thermal image generation unit 26. In this example, the background has higher intensity than the subject.

Hereinafter, a method by which the environment determination unit 30 calculates a temperature subtraction value will be described. However, the calculation method is not limited to the method described below.

A first method will be described with reference to FIG. 11. FIG. 11 schematically shows a frequency distribution of pixel values in a corrected thermal image output by the thermal image generation unit 26. The dashed line indicates the position of the pixel mean value, which is the average of the pixel values in the corrected thermal image. When the subject (“Human information”) is at a lower temperature than the background, the pixel mean value shifts toward the low-temperature side. That is, the pixel mean value becomes a negative value. On the other hand, when the subject (“Human information”) is at a higher temperature than the background, the pixel mean value shifts toward the high-temperature side, and the pixel mean value becomes a positive value. Therefore, the pixel mean value is used as the temperature subtraction value.

Another method will be described with reference to FIG. 12. FIG. 12 schematically shows a frequency distribution of pixel values in a corrected thermal image output by the thermal image generation unit 26. In the figure, the dashed line on the left indicates a threshold thP having a negative value, and the dashed line on the right indicates a threshold thQ having a positive value. Let n be the number of pixels with values smaller than thP, and m be the number of pixels with values larger than thQ. In this case, if n>m, it can be determined that the subject temperature is lower than the background temperature. If n≤m, it can be determined that the subject temperature is not lower than the background temperature. Therefore, the value m−n is used as the temperature subtraction value.

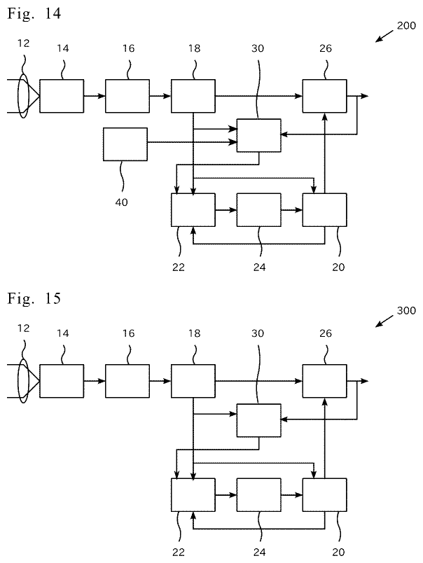

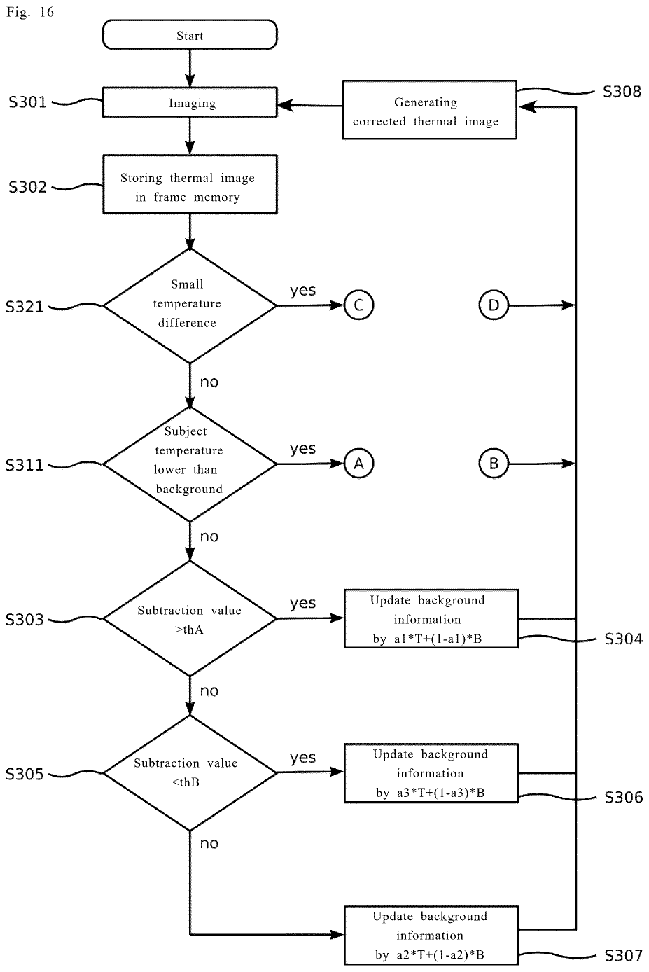

Another method will be described with reference to FIG. 13. FIG. 13 schematically shows a frequency distribution of pixel values in a corrected thermal image output by the thermal image generation unit 26. The subject is a human or the like, and often moves within the thermal image. The dashed line in the figure schematically represents the movement of the subject. By determining whether the value of regions whose values vary over time is positive or negative in this manner, the relative temperature of the subject and the background can be determined. That is, if the value in the subject region is negative, it is determined that the subject temperature is lower than the background temperature, and if the value is not negative, it is determined that the subject temperature is not lower than the background temperature. Therefore, among the frequency regions in FIG. 13, the region that varies most over time is determined to be the subject region, and the mean value of the subject region is used as the temperature subtraction value.

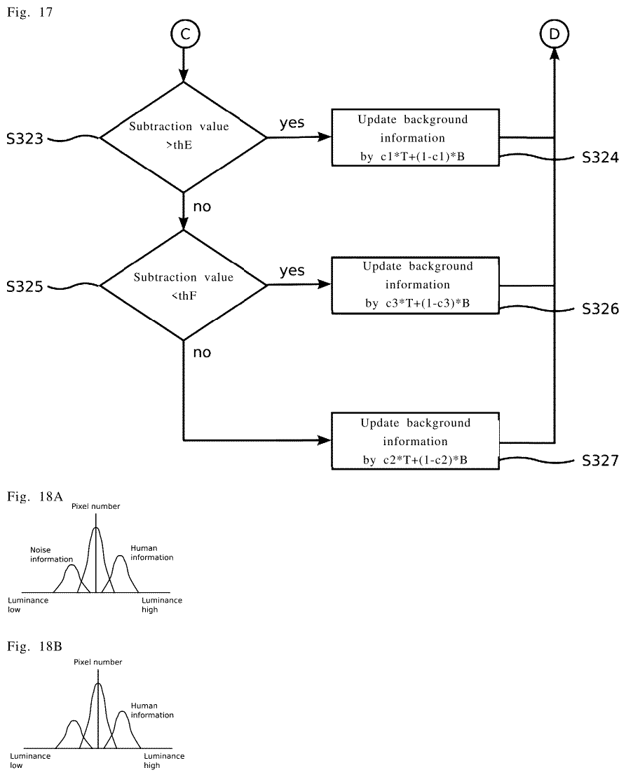

Another method will be described with reference to FIG. 14. FIG. 14 shows a modified configuration of the infrared imaging device 200, in which a thermometer 40 is additionally provided. The thermometer 40 measures a temperature near the surroundings or background of the infrared imaging device 200. The measured temperature is used as the measurement temperature. The measurement temperature is transmitted to the environment determination unit 30. The environment determination unit 30 calculates a temperature corresponding to the mean value of each pixel (pixel mean value) of the thermal image stored in the frame memory 18 (thermal image temperature). A pre-established correspondence between the pixel mean value and the thermal image temperature may be used. The measurement temperature is considered to be close to the background temperature. Furthermore, when the subject is imaged in the thermal image stored in the frame memory 18, the thermal image temperature shifts toward the subject temperature side from the background temperature. Therefore, a value obtained by subtracting the measurement temperature from the thermal image temperature is used as the temperature subtraction value. The thermometer 40 may be a thermistor, a non-contact radiation thermometer, or any other suitable device.

As another method, the subject may be identified, and the temperature of the identified subject may be estimated. The subject identification method may be based on the shape of the subject, may identify an intruder from outside the imaging area as a subject, may identify a subject based on movement speed within the image, or may be based on other image evaluation methods.

As described above, the infrared imaging device 200 according to the second embodiment determines whether the subject temperature is lower than the background temperature. When it is determined that the subject temperature is not lower than the background temperature, the device operates so that the determinations of subject imaging state, background imaging state, and false detection state are appropriately made. Accordingly, stable imaging is possible even when the subject temperature is lower than the background temperature.

### Third Embodiment

FIG. 15 shows a configuration of an infrared imaging device 300 according to the third embodiment. The infrared imaging device 300 according to the third embodiment is similar to the infrared imaging device 200 according to the second embodiment, but the environment determination unit 30 also determines whether the subject temperature is close to the background temperature and changes operation according to the determination result.

Hereinafter, the operation of the infrared imaging device 300 according to the third embodiment will be described. FIGS. 16 and 17 are flowcharts showing the operation of the infrared imaging device 300. C in FIG. 16 connects to C in FIG. 17, and D in FIG. 17 connects to D in FIG. 16. A in FIG. 16 connects to A in FIG. 8 of the second embodiment described above, and B in FIG. 16 connects to B in FIG. 8. Steps S301 to S302 are the same as steps S201 to S202 in FIG. 7 of the second embodiment; thus, description is omitted.

In step S321, which follows step S302, the environment determination unit 30 determines whether the subject temperature is close to the background temperature. Specifically, it determines whether the absolute value of the temperature subtraction value described in the second embodiment is smaller than a positive threshold thU.

If the absolute value of the temperature subtraction value is determined not to be smaller than thU, the process proceeds to step S311. Steps from S311 onward are the same as steps S211 onward in FIG. 7 of the second embodiment; thus, description is omitted.

If the absolute value of the temperature subtraction value is determined to be smaller than thU in step S321, the process proceeds to step S323, where a state determination is performed by the state determination unit 22. Steps S323 to S327 are similar to steps S103 to S107 in FIG. 2 of the first embodiment. In step S323, for each pixel, if the subtraction value obtained by subtracting the background information stored in the background information memory 20 from the thermal image stored in the frame memory 18 is determined to be larger than a positive threshold thE, the pixel is determined to be in a subject imaging state.

When a pixel is determined to be in the subject imaging state, in step S324, the background information update unit 24 updates and stores the background information memory 20 with a new background value calculated by the formula c1*T+(1−c1)*B using a number c1 satisfying 0<c1<1.

If a pixel is not determined to be in the subject imaging state in step S323, the process proceeds to step S325. For each pixel, if the subtraction value is larger than a negative threshold thF, the pixel is determined to be in a false detection state.

If a pixel is determined to be in the false detection state, in step S326, the background information update unit 24 updates and stores the background information memory 20 with a new background value calculated by the formula c3*T+(1−c3)*B using a number c3 satisfying 0<c3<1.

If a pixel is not determined to be in the false detection state in step S325, the pixel is considered to be in a background imaging state, and in step S327, the background information update unit 24 updates and stores the background information memory 20 with a new background value calculated by the formula c2*T+(1−c2)*B using a number c2 satisfying 0<c2<1.

Here, for the same reasons as described in the first embodiment, it is desirable that c1<c2<c3. However, this relationship is not limiting due to constraints such as the time required for image smoothing and the required degree of image smoothness.

It is further desirable that c1<a3 and c3<a3. When the subject and background temperatures are close, it is difficult to make correct determinations of the subject imaging state, background imaging state, and false detection state. Therefore, in order to suppress rapid changes in the output image, c3<a3 should be satisfied, reducing the proportion of the thermal image stored in the frame memory 18 used for updating the background information.

After completing any of steps S324, S326, or S327, the process proceeds to step S308, which corresponds to step S208 in FIG. 7 of the second embodiment.

Hereinafter, temporal changes of the corrected thermal image output by the thermal image generation unit 26 will be described. FIG. 18(a) schematically shows a frequency distribution of pixel values in the corrected thermal image output by the thermal image generation unit 26. This example corresponds to a case where the temperature difference between the subject and the background is small.

In the third embodiment, both c1 and c3 used in the function f(a, T, B) for updating the background information are smaller than a3 of the first embodiment. Therefore, the decay of the subject information is small. As a result, as shown in FIG. 18(b), the decay of the subject over time is small.

As described above, the infrared imaging device 300 according to the third embodiment determines whether the subject temperature is close to the background temperature. When it is determined that the temperature difference is small, the device outputs an image in which the decay of subject information is small, thereby enabling stabilization of the output image.

### Fourth Embodiment

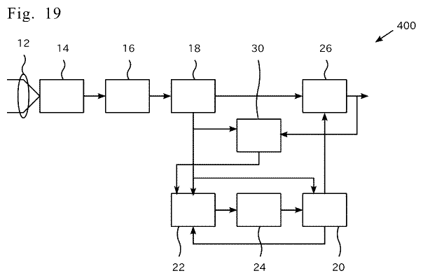

FIG. 19 shows a configuration of an infrared imaging device 400 according to the fourth embodiment. The infrared imaging device 400 according to the fourth embodiment is similar to the infrared imaging device 200 according to the second embodiment, but the environment determination unit 30 also determines whether the subject temperature is significantly different from the background temperature and changes operation according to the determination result.

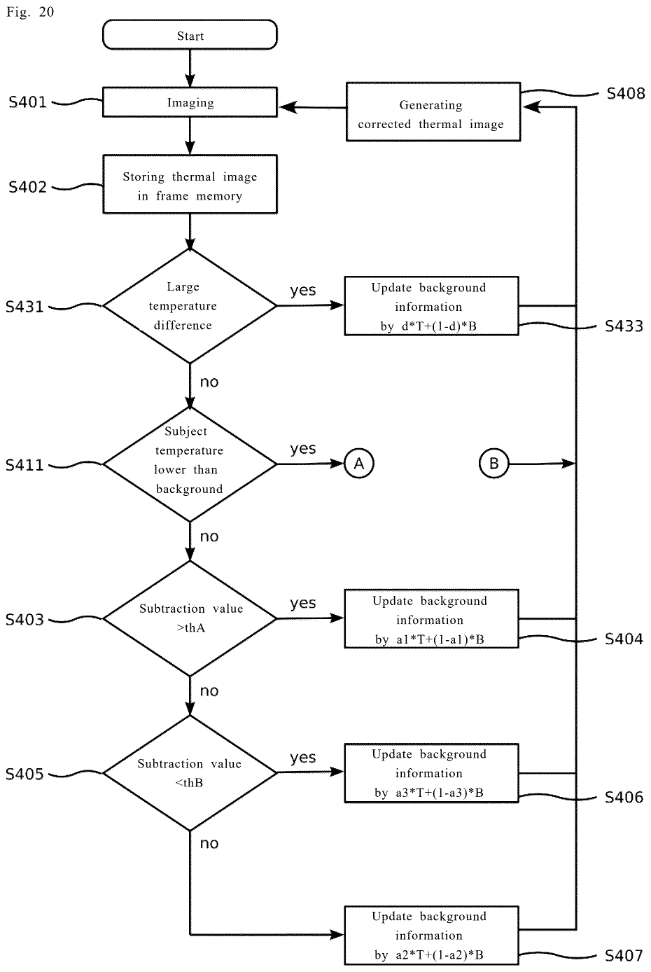

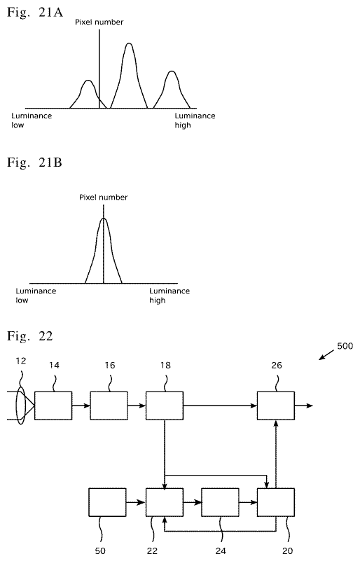

Hereinafter, the operation of the infrared imaging device 400 according to the fourth embodiment will be described. FIG. 20 is a flowchart showing the operation of the infrared imaging device 400. A in FIG. 20 connects to A in FIG. 8 of the second embodiment described above, and B in FIG. 20 connects to B in FIG. 8. Steps S401 to S402 are the same as steps S201 to S202 in FIG. 7 of the second embodiment; thus, description is omitted.

In step S431, which follows step S402, the environment determination unit 30 determines whether the subject temperature is significantly different from the background temperature.

Specifically, it determines whether the absolute value of the temperature subtraction value described in the second embodiment is greater than a positive threshold thV.

If the absolute value of the temperature subtraction value is determined not to be greater than th V, the process proceeds to step S411. Steps from S411 onward are the same as steps S211 onward in FIG. 7 of the second embodiment; thus, description is omitted.

If the absolute value of the temperature subtraction value is determined to be greater than th V in step S431, the process proceeds to step S433, where the background information update unit 24 updates and stores the background information memory 20 with a new background value calculated by the formula d*T+(1−d)*B using a number d satisfying 0<d<1.

It is desirable that the number d satisfy d>a3. In cases such as when direct sunlight or hot air hits the infrared imaging device 400, causing a sudden change in environmental temperature, the image output from the thermal image generation unit 26 changes rapidly. In such cases, subject imaging performance is significantly degraded, and rapid image recovery is necessary. Therefore, it is important to increase the value of d so that the information of the thermal image stored in the frame memory 18 is reflected at a higher ratio in the background information stored in the background information memory 20.

After step S433 is completed, the process proceeds to step S408, which corresponds to step S208 in FIG. 7 of the second embodiment.

Hereinafter, temporal changes of the corrected thermal image output by the thermal image generation unit 26 will be described. FIG. 21(a) schematically shows a frequency distribution of pixel values in the corrected thermal image output by the thermal image generation unit 26. This example corresponds to a case where the subject and background temperatures are determined to be significantly different.

Normally, the background region is near zero (indicated by the position of the bars on the vertical axis in the figure). However, in situations where the subject and background temperatures are significantly different, the distribution shifts largely toward the high-temperature side or the low-temperature side, including the background region, as shown in FIG. 21(a).

In the fourth embodiment, even in such situations, by increasing the value of d, the information of the thermal image stored in the frame memory 18 is strongly reflected in the background information, allowing the image to recover quickly, as shown in FIG. 21(b).

As described above, the infrared imaging device 400 according to the fourth embodiment determines whether the subject temperature is significantly different from the background temperature. When it is determined that the temperature difference is large, the information of the thermal image stored in the frame memory 18 is strongly reflected in the background information, thereby achieving early image recovery.

### Fifth Embodiment

FIG. 22 shows a configuration of an infrared imaging device 500 according to the fifth embodiment. The infrared imaging device 500 according to the fifth embodiment is similar to the infrared imaging device 100 according to the first embodiment, but includes a timing determination unit 50 that determines whether the infrared imaging device 500 is in a startup state, and changes operation according to the determination result.

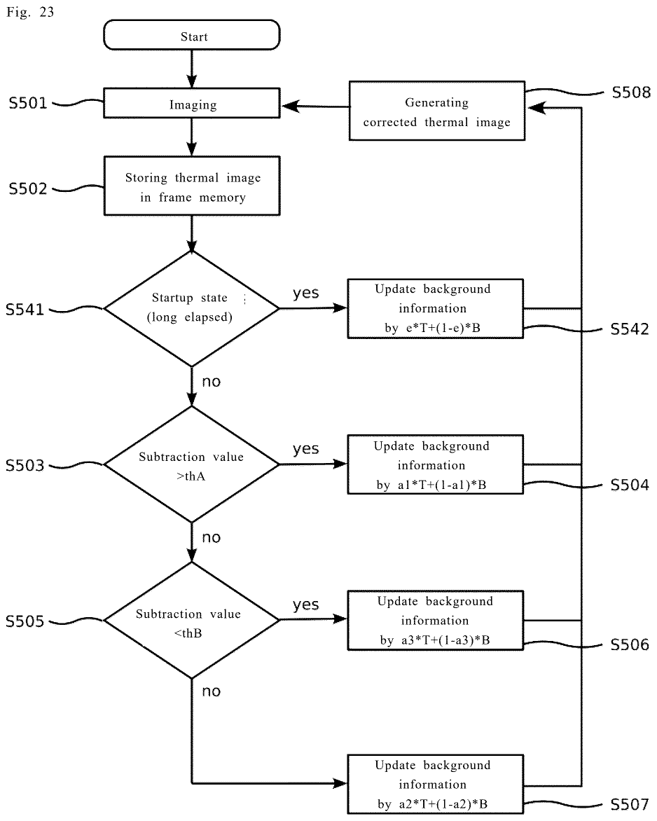

Hereinafter, the operation of the infrared imaging device 500 according to the fifth embodiment will be described. FIG. 23 is a flowchart showing the operation of the infrared imaging device 500. Steps S501 to S502 are the same as steps S501 to S502 in FIG. 2 of the first embodiment; thus, description is omitted.

In step S541, which follows step S502, the timing determination unit 50 determines whether the infrared imaging device 500 is in a startup state.

If the infrared imaging device 500 is determined not to be in a startup state, the process proceeds to step S503. Steps from S503 onward are the same as steps S103 onward in FIG. 2 of the first embodiment; thus, description is omitted.

If the infrared imaging device 500 is determined to be in a startup state in step S541, the process proceeds to step S542, where the background information update unit 24 updates and stores the background information memory 20 with a new background value calculated by the formula e*T+(1−e)*B using a number e satisfying 0<e<1.

It is desirable that the number e satisfy e>a3. When the infrared imaging device 500 is in a startup state, the image output from the thermal image generation unit 26 is unstable.

Unnecessary subjects may also be captured. In such cases, the background information stored in the background information memory 20 becomes unstable, significantly degrading subject imaging performance, and early image recovery is necessary. Therefore, it is important to increase the value of e so that the information of the thermal image stored in the frame memory 18 is strongly reflected in the background information stored in the background information memory 20.

After step S542 is completed, the process proceeds to step S508, which corresponds to step S108 in FIG. 2 of the first embodiment.

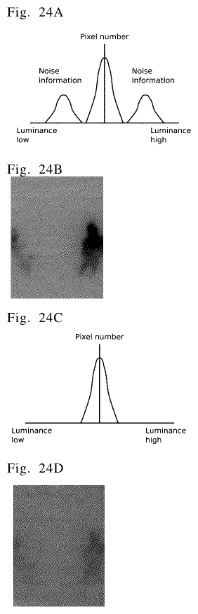

Hereinafter, temporal changes of the corrected thermal image output by the thermal image generation unit 26 will be described. FIG. 24(a) schematically shows a frequency distribution of pixel values in the corrected thermal image output by the thermal image generation unit 26. A corresponding output image is also shown on the right side of the schematic frequency diagram. This example corresponds to a case in which the infrared imaging device 500 is determined to be in a startup state.

When the infrared imaging device 500 is in a startup state, as described above, it is necessary to recover quickly from the degraded subject imaging performance. In the fifth embodiment, even in such situations, by increasing the number e, the information of the thermal image stored in the frame memory 18 is strongly reflected in the background information, allowing the image to recover quickly as shown in FIG. 24(b).

Hereinafter, a method by which the timing determination unit 50 determines whether the infrared imaging device 500 is in a startup state will be described. However, the determination method is not limited to the following methods.

A first method is that the timing determination unit 50 is equipped with a function for measuring the elapsed time after startup of the infrared imaging device 500 and determines whether the device is in a startup state based on whether the elapsed time is smaller than a positive threshold thX. For example, the elapsed time may be measured by a component with a clock function, or a microcontroller timer function may be used.

Another method is to count the number of times thermal images are stored in the frame memory 18. The timing determination unit 50 counts the number of times thermal images have been stored in the frame memory 18. This count is treated as the elapsed time since the infrared imaging device 500 was started, and whether the count is smaller than the positive threshold thX is used to determine whether the infrared imaging device 500 is in a startup state.

Another method is to count the number of operations of ADC16. This method replaces the number of storage operations in the first method with the number of ADC16 operations.

As described above, the infrared imaging device 500 according to the fifth embodiment determines whether it is in a startup state. When it is determined that the device is in a startup state, the information of the thermal image stored in the frame memory 18 is strongly reflected in the background information, thereby achieving early image recovery.

As a modification of the infrared imaging device 500 according to the fifth embodiment, instead of determining whether the device is in a startup state, the timing determination unit 50 may determine whether a long time has elapsed after startup. When it is determined that a long time has elapsed, the thermal image information stored in the frame memory 18 is reflected in the background information in the same manner as described above. Specifically, the timing determination unit 50 determines whether the time elapsed since the infrared imaging device 500 was started is longer than a positive threshold thY. If it is longer, the background information is updated using a number g satisfying 0<g<1 in place of e. It is desirable that g satisfy g>a3.

When the infrared imaging device 500 operates for a long period, a large amount of information accumulates in the background information stored in the background information memory 20, which may require resetting. In this modification, early recovery of the background information can be achieved in such cases.

The timing determination unit 50 may be an independent component, or its function may be implemented in another component, such as the state determination unit 22.

As described above, in any of embodiments 1 to 5, the state determination unit may determine the subject imaging state, background imaging state, and false detection state, or may omit false detection determination and only determine the subject and background imaging states. Alternatively, the number a used in the function f(a, T, B) may be set to values suitable for each state if additional states are added.

Moreover, the pixel average value, which is the average of pixel values in the corrected thermal image, may be calculated using all pixels or a subset of selected pixels.

Furthermore, the infrared imaging device may be a standalone finished product or a module incorporated into another product.

This disclosure describes various exemplary embodiments and examples. Features, aspects, and functions described in one or more embodiments are not limited to application in a specific embodiment and may be applied individually or in various combinations to any embodiment.

Therefore, numerous modifications not explicitly described can be considered within the scope of the technology disclosed in this specification. For example, modifications may include changing, adding, or omitting at least one component, or extracting at least one component and combining it with components of other embodiments.

### REFERENCE SIGNS LIST

100, 200, 300, 400, 500 Infrared imaging device; 14 Imaging element; 16 ADC; 18 Frame memory; 20 Background information memory; 22 State determination unit; 24 Background information update unit; 26 Thermal image generation unit; 30 Environment determination unit; 40 Thermometer; 50 Timing determination unit.

1. An infrared imaging device comprising:
an imaging element that receives infrared light emitted from an imaging target region including a subject and a background and outputs an electric signal according to intensity of the infrared light;
an ADC that converts the electric signal into a digital signal;
a frame memory that stores the digital signal as a thermal image;
a background information memory that stores background information calculated based on the thermal image;
a state determination circuitry that determines whether a subtraction value obtained by subtracting the background information from the thermal image is greater than thA that is a positive threshold for each pixel;
a background information update circuitry that updates and stores in the background information memory as new background information, a value obtained by calculating a function f(a, T, B) in which a ratio of T between the T and B increases in association with increase of a while setting a value of the thermal image as the T, setting a value of the background information as the B, and using a number a, for each pixel; and
a thermal image generation circuitry that subtracts the background information from the thermal image for each pixel and outputs the result as a corrected thermal image,
wherein the state determination circuitry sets a value of the a in a case where it is determined that the subtraction value is greater than the thA as a1, and sets the value of the a in a case where it is determined that the subtraction value is not greater than the thA as a2, and the a1 and the a2 satisfy an expression a1<a2.

2. The infrared imaging device according to claim 1, wherein the a satisfies an expression 0<a<1, and the function f(a, T, B) is f(a, T, B)=a*T+(1−a)*B.

3. The infrared imaging device according to claim 1, wherein
only in a case where the state determination circuitry determines that the subtraction value is not greater than the thA,
the state determination circuitry determines whether the subtraction value is smaller than thB that is a negative threshold, and
the state determination circuitry sets the value of the a in a case where it is determined that the subtraction value is smaller than the thB as a3, the value of the a in a case where it is determined that the subtraction value is not smaller than the thB is the a2, and the a1, the a2, and the a3 satisfy an expression a1<a2<a3.

4. The infrared imaging device according to claim 1, comprising:
an environment determination circuitry that calculates a temperature subtraction value corresponding to a value obtained by subtracting a representative value of a temperature of the background from a representative value of a temperature of the subject,
wherein the environment determination circuitry determines whether the temperature subtraction value is a negative value, and
only in a case where the environment determination circuitry determines that the temperature subtraction value is a negative value, the state determination circuitry determines whether the subtraction value is smaller than thC that is a negative threshold for each pixel, sets the value of the a in a case where it is determined that the subtraction value is smaller than the thC as b1, and sets the value of the a in a case where it is determined that the subtraction value is not smaller than the thC as b2, and the b1 and the b2 satisfy an expression b1<b2.

5. The infrared imaging device according to claim 4, wherein only in a case where the environment determination circuitry determines that the temperature subtraction value is a negative value, and the state determination circuitry determines that the subtraction value is not smaller than the thC, the state determination circuitry determines whether the subtraction value is greater than thD that is a positive threshold for each pixel, and the state determination circuitry sets the value of the a in a case where it is determined that the subtraction value is greater than the thD as b3, the value of the a in a case where it is determined that the subtraction value is not greater than the thD is the b2, and the b1, the b2, and the b3 satisfy an expression b1<b2<b3.

6. The infrared imaging device according to claim 4,
wherein the environment determination circuitry determines whether an absolute value of the temperature subtraction value is smaller than thU that is a positive threshold,
only in a case where the environment determination circuitry determines that the absolute value of the temperature subtraction value is smaller than the thU, the state determination circuitry determines whether the subtraction value is greater than thE that is a positive threshold for each pixel, sets the value of the a in a case where it is determined that the subtraction value is greater than the thE as c1, and in a case where it is determined that the subtraction value is not greater than the thE, determines whether the subtraction value is smaller than thF that is a negative threshold for each pixel, sets the value of the a in a case where it is determined that the subtraction value is not smaller than the thF as c2, and sets the value of the a in a case where it is determined that the subtraction value is smaller than the thF as c3, the c1 satisfies an expression c1<a3, and the c3 satisfies an expression c3<a3.

7. The infrared imaging device according to claim 4,
wherein the environment determination circuitry determines whether an absolute value of the temperature subtraction value is greater than th V that is a positive threshold, and
only in a case where the environment determination circuitry determines that the absolute value of the temperature subtraction value is greater than the thV, the state determination circuitry sets the value of the a as d, and the d satisfies an expression d>a3.

8. The infrared imaging device according to claim 4, wherein the environment determination circuitry calculates a pixel average value that is an average of values of all pixels or partially extracted pixels of the corrected thermal image and sets the pixel average value as the temperature subtraction value.

9. The infrared imaging device according to claim 4, wherein the environment determination circuitry sets the number of pixels having values smaller than thP that is a negative threshold among all pixels or partially extracted pixels of the corrected thermal image as n, sets the number of pixels having values greater than thQ that is a positive threshold as m, and sets a value of m−n as the temperature subtraction value.

10. The infrared imaging device according to claim 4, wherein the environment determination circuitry examines the frequency of values of all pixels or partially extracted pixels of the corrected thermal image, determines, among regions of the frequency, the region whose values vary most over time to be the subject region, and uses the average value of the subject region as the temperature subtraction value.

11. The infrared imaging device according to claim 4, comprising a thermometer that measures a measured temperature,
wherein the environment determination circuitry sets a temperature corresponding to an average value of values of all pixels or partially extracted pixels of the thermal image as a thermal image temperature and sets a value obtained by subtracting the measured temperature from the thermal image temperature as the temperature subtraction value.

12. The infrared imaging device according to claim 1, comprising a timing determination circuitry that determines whether a period from when the infrared imaging device is activated is shorter than thX that is a positive threshold,
wherein only in a case where the timing determination circuitry determines that the period from when the infrared imaging device is activated is shorter than the thX, a number e that satisfies an expression e>a3 is used as the value of the a that is an argument of the function f(a, T, B).

13. The infrared imaging device according to claim 1, comprising a timing determination circuitry that determines whether a period from when the infrared imaging device is activated is longer than th Y that is a positive threshold,
wherein only in a case where the timing determination circuitry determines that the period from when the infrared imaging device is activated is longer than the thY, a number g that satisfies an expression g>a3 is used as the value of the a that is an argument of the function f(a, T, B).
